(19) United States
(12) Patent Application Publication
(10) Pub. No.: US 2020/0223374 A1
(43) Pub. Date: Jul. 16, 2020

(54) ATTACHING STRUCTURE FOR BRACKET

(71) Applicant: KABUSHIKI KAISHA TOYOTA JIDOSHOKKI, Kariya-shi (JP)

(72) Inventor: Kenta KONDO, Kariya-shi (JP)

(73) Assignee: KABUSHIKI KAISHA TOYOTA JIDOSHOKKI, Kariya-shi (JP)

(21) Appl. No.: 16/739,231

(22) Filed: Jan. 10, 2020

(30) Foreign Application Priority Data
Jan. 15, 2019 (JP) 2019-004403

(51) Int. Cl. B60R 11/02; B60R 11/00

(52) U.S. Cl. CPC B60R 11/0264; B60R 2011/0059; E05Y 2400/858; B60R 2011/004

(57) ABSTRACT

An attaching structure for a bracket used to attach a kick sensor to a body of a vehicle includes a bracket attachment portion arranged on the bracket, an attaching portion arranged on the body, and a fastener that couples the bracket attachment portion and the attaching portion to each other. The fastener is attachable to and detachable from the bracket attachment portion and the attaching portion.

### 1. FIELD

The present disclosure relates to an attaching structure for a bracket used to attach a kick sensor to the body of a vehicle.

### 2. DESCRIPTION OF RELATED ART

Japanese Laid-Open Patent Publication No. 2017-141640 discloses a vehicle including a body to which a kick sensor that detects the motion of a leg of a user is attached. In the vehicle, the kick sensor detects the motion of a leg of a user. This allows the sliding door or the back door of the vehicle to open and close automatically. Generally, a bracket is used to attach the kick sensor to the body.

The bracket used to attach the kick sensor to the body is typically attached to the body using a double-sided tape. For example, when the double-sided tape is used to remove the bracket attached to the body from the body in order to do maintenance, the bracket is forcibly separated from the body. At this time, the double-sided tape is taken off from the bracket or the body. The double-sided tape that has once been taken off from the bracket or the body has a decreased adhesiveness. Thus, if the double-sided tape taken off once is used to attach the bracket to the body again, the bracket is attached to the body unstably. This reduces the reliability of attaching the bracket to the body.

In order to ensure the reliability of attaching the bracket to the body, a new double-sided tape may be used to attach the bracket to the body again. However, a new double-sided tape needs to be prepared every time the double-sided tape is taken off, thereby increasing the cost.

### SUMMARY

It is an objective of the present disclosure to provide an attaching structure for a bracket that ensures the reliability of attaching a bracket to a body while reducing the cost.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An attaching structure for a bracket according to an aspect of the present disclosure is used to attach a kick sensor to a body of a vehicle. The attaching structure includes a bracket attachment portion arranged on the bracket, an attaching portion arranged on the body, and a fastener that couples the bracket attachment portion and the attaching portion to each other. The fastener is attachable to and detachable from the bracket attachment portion and the attaching portion.

Other features and aspects will be apparent from the following detailed description, the drawings, and the claims.

### BRIEF DESCRIPTION OF THE DRAWINGS

FIG. 1 is a side view schematically showing the rear part of a vehicle in an embodiment.

FIG. 2 is a perspective view of the rear bumper, the bracket, and the kick sensor of the vehicle shown in FIG. 1.

FIG. 3 is a cross-sectional view taken along line 3-3 in FIG. 2.

FIG. 4 is a cross-sectional view taken along line 4-4 in FIG. 2.

FIG. 5 is a cross-sectional view taken along line 5-5 in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

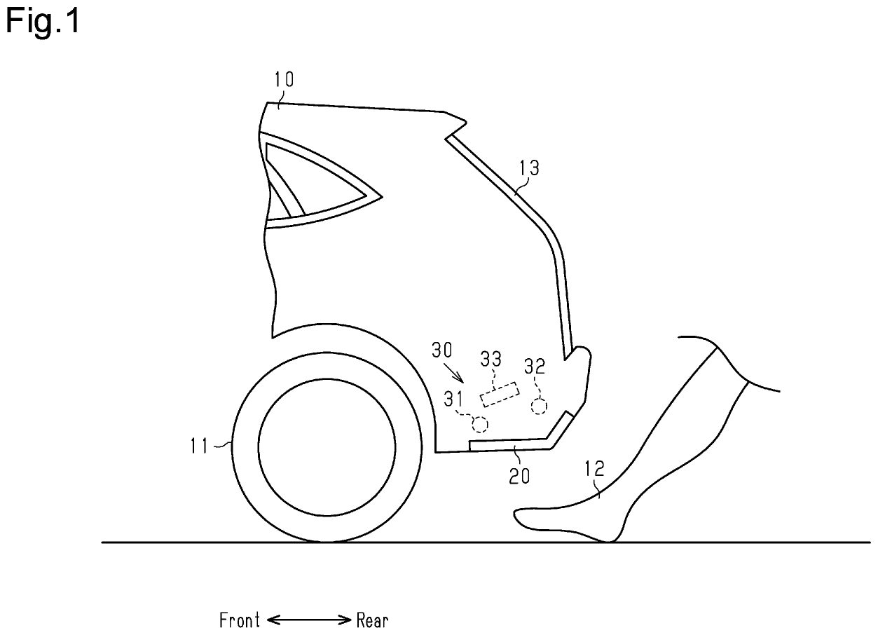

An attaching structure for a bracket 40 according to an embodiment will now be described with reference to FIGS. 1 to 5. The bracket 40 of the present embodiment is used to attach a kick sensor 30 to a rear bumper 20, which is part of the body of the vehicle 10. For purposes of illustration, the direction indicating the front, rear, left, and right in the drawings respectively define the directions of the front, rear, top, and bottom of the vehicle 10. The left-right direction of the vehicle 10 is the width direction of the vehicle.

As shown in FIG. 1, the rear bumper 20 of the vehicle 10 is located at the lower part of the vehicle 10 and at the rear of a rear wheel 11 of the vehicle 10, which is a wheel. The kick sensor 30 is attached to the rear bumper 20. The kick sensor 30 detects the motion of a leg 12 of the user. The kick sensor 30 includes a first sensor electrode 31, a second sensor electrode 32, and a sensor ECU 33. The first and second sensor electrodes 31 and 32 are electric wires electrically connected to the sensor ECU 33. Each of the first and second sensor electrodes 31 and 32 has a predetermined detection range. The kick sensor 30 is a capacitive proximity sensor that detects capacitance changes between each of the first and second sensor electrodes 31 and 32 and the leg 12 of the user in the corresponding detection range. The sensor ECU 33 controls the opening and closing of a back door 13 of the vehicle 10 based on the capacitance changes. The kick sensor 30 detects the motion of the leg 12 of the user, thereby enabling the back door 13 of the vehicle 10 to open and close automatically.

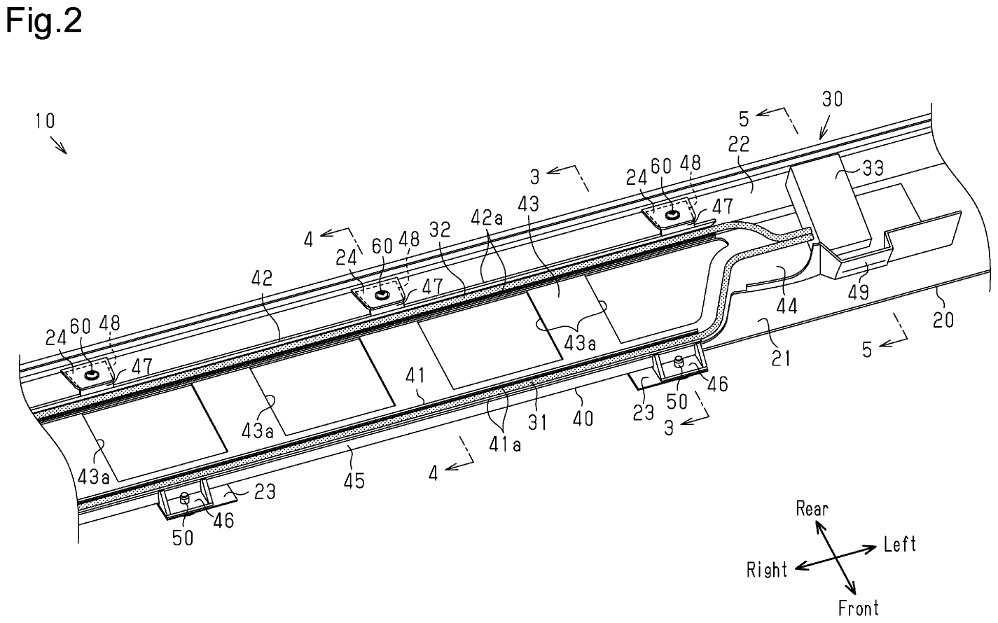

As shown in FIGS. 2, 3, and 4, the kick sensor 30 is attached to the rear bumper 20 by the bracket 40. The rear bumper 20 is made of, for example, iron. The rear bumper 20 includes an elongated plate-shaped bumper body 21, which extends in the left-right direction. The bumper body 21 extends horizontally in the left-right direction and extends obliquely with respect to the front-rear direction. The longitudinal direction of the bumper body 21 is the left-right direction of the vehicle 10. The transverse direction of the bumper body 21 is orthogonal to the longitudinal direction and is oblique with respect to the front-rear direction.

Further, the rear bumper 20 includes an elongated plate-shaped bumper extension 22, which extends diagonally upward to the rear from the rear edge of the bumper body 21. The longitudinal direction of the bumper extension 22 is the left-right direction of the vehicle 10. The transverse direction of the bumper extension 22 is oblique with respect to the transverse direction of the bumper body 21.

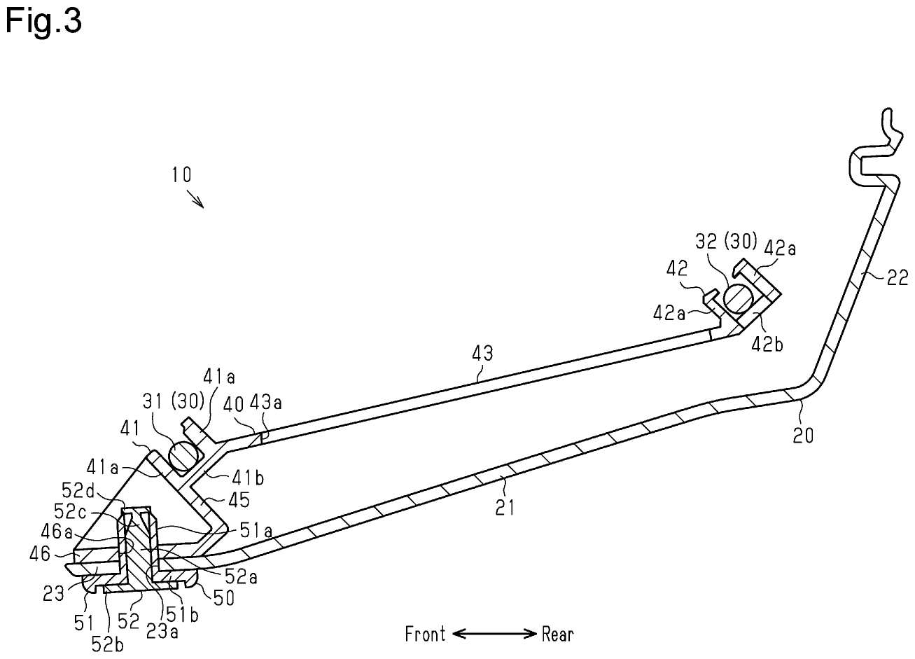

As shown in FIGS. 2 and 3, the rear bumper 20 includes two plate-shaped first bumper-side attachment portions 23. The first bumper-side attachment portions 23 project frontward from the front end of the bumper body 21. The two first bumper-side attachment portions 23 are spaced apart from each other by a predetermined distance in the longitudinal direction of the bumper body 21. Each first bumper-side attachment portion 23 has a circular first insertion hole 23a. Each first insertion hole 23a extends through the corresponding first bumper-side attachment portion 23 in the thickness direction.

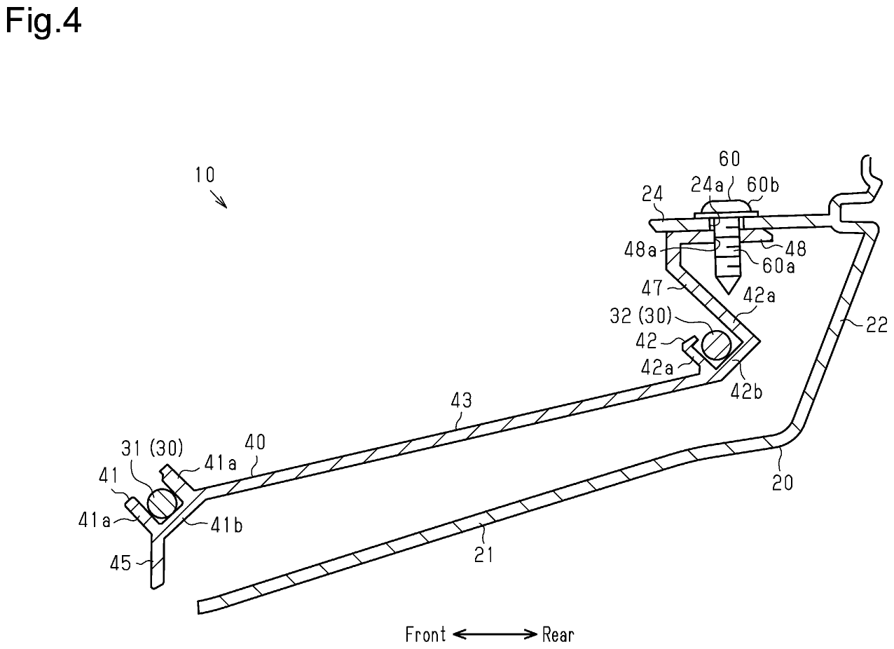

As shown in FIGS. 2 and 4, the rear bumper 20 includes three plate-shaped second bumper-side attachment portions 24. The second bumper-side attachment portions 24 project frontward from the edge of the bumper extension 22 on the opposite side from the bumper body 21. The three second bumper-side attachment portions 24 are spaced apart from each other by a predetermined distance in the longitudinal direction of the bumper extension 22. Each second bumper-side attachment portion 24 has a circular second insertion hole 24a. Each second insertion hole 24a extends through the corresponding first bumper-side attachment portion 24 in the thickness direction.

The bracket 40 is made of, for example, iron. The bracket 40 includes first and second holders 41 and 42, which respectively hold the first and second sensor electrodes 31 and 32.

As shown in FIGS. 2, 3, and 4, the first holder 41 includes two elongated plate-shaped guide portions 41a, which guide the first sensor electrode 31, and an elongated plate-shaped connection portion 41b. The connection portion 41b connects basal edges (first ends in the transverse direction) of the two guide portions 41a to each other. The two guide portions 41a extend in parallel to each other. The transverse direction of the connection portion 41b is orthogonal to the transverse direction of the guide portions 41a. The two edges of the connection portion 41b in the transverse direction respectively extend over the entire basal edges of the two guide portions 41a. The first holder 41 has a U-shaped cross-sectional shape.

The second holder 42 includes elongated plate-shaped two guide portions 42a, which guide the second sensor electrode 32, and three plate-shaped connection portions 42b. The three connection portions 42b connect basal edges (first ends in the transverse direction) of the two guide portions 42a to each other. The two guide portions 42a extend in parallel to each other. The longitudinal direction of the two guide portions 42a of the second holder 42 correspond to the longitudinal direction of the two guide portions 41a of the first holder 41. The three connection portions 42b are spaced apart from each other by a predetermined distance in the longitudinal direction of the guide portion 42a. The distance between the connection portions 42b adjacent to each other in the longitudinal direction of the guide portions 42a is substantially the same as the second bumper-side attachment portions 24 adjacent to each other in the longitudinal direction of the bumper extension 22. The three connection portions 42b connect basal edges of the two guide portions 42a to each other at three different positions that are separated from each other.

The bracket 40 includes an elongated plate-shaped coupling portion 43, which couples the first holder 41 and the second holder 42 to each other. The longitudinal direction of the coupling portion 43 corresponds to the longitudinal directions of the guide portions 41a and 42a. A first edge of the coupling portion 43 in the transverse direction is coupled to the basal edge of the guide portion 41a that is closer to the second holder 42. A second edge of the coupling portion 43 in the transverse direction is coupled to the basal edge of the guide portion 42a that is closer to the first holder 41. The coupling portion 43 extends over the entire the guide portions 41a and 42a.

As shown in FIGS. 2 and 3, the coupling portion 43 has through holes 43a, which are laid out in the longitudinal direction. The through holes 43a are arranged between the first holder 41 and the second holder 42. The through holes 43a of the coupling portion 43 reduce the weight of the bracket 40.

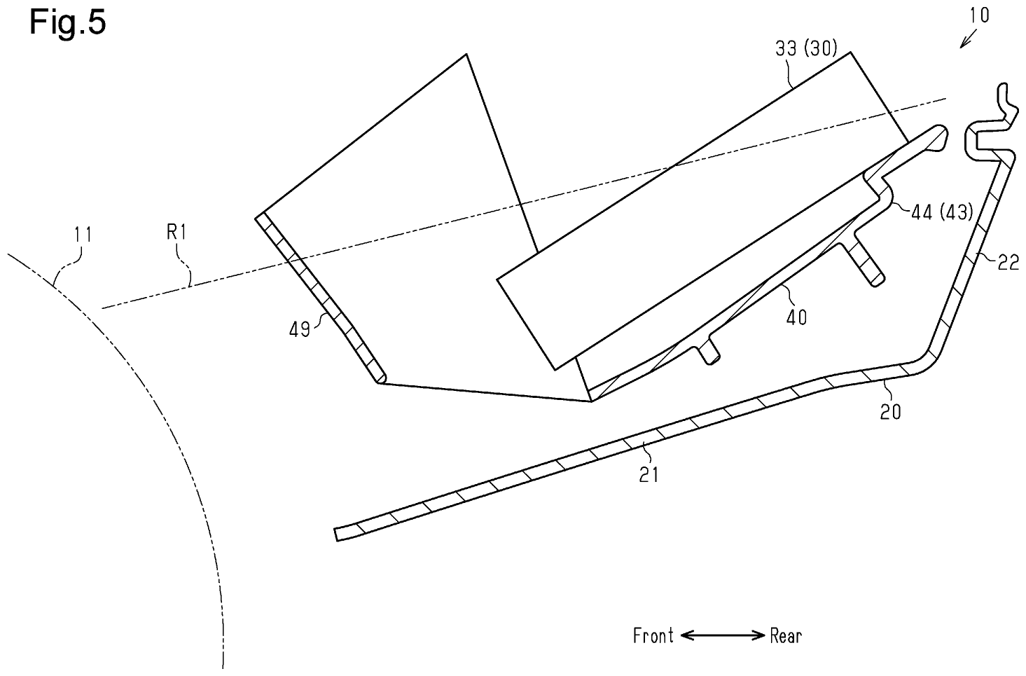

As shown in FIGS. 2 and 5, a first end of the coupling portion 43 in the longitudinal direction extends outward in the width direction beyond the first holder 41 and the second holder 42. The sensor ECU 33 is attached to a part of the coupling portion 43 extending to the first end beyond the first holder 41 and the second holder 42. Thus, the bracket 40 includes an ECU attachment portion 44, to which the sensor ECU 33 is attached. The ECU attachment portion 44 is a portion of the coupling portion 43 that projects from the first holder 41 and the second holder 42 in the longitudinal direction.

As shown in FIGS. 2 and 3, the bracket 40 includes an elongated plate-shaped first extension 45. The first extension 45 extends from the basal edge of one of the guide portions 41a of the first holder 41 that is farther from the second holder 42. The longitudinal direction of the first extension 45 corresponds to the longitudinal direction of the guide portion 41a. The transverse direction of the first extension 45 corresponds to the transverse direction of the guide portion 41a. The basal edge (first end in the transverse direction) of the first extension 45 extends over the entire basal edge of the corresponding guide portion 41a.

The bracket 40 includes two plate-shaped first bracket attachment portions 46. The first bracket attachment portions 46 project frontward from a second end of the first extension 45 in the transverse direction, that is, project in a direction away from the second holder 42. The two first bracket attachment portions 46 are spaced apart from each other by a predetermined distance in the longitudinal direction of the first extension 45. The distance between the two first bracket attachment portions 46 is substantially the same as the distance between the two first bumper-side attachment portions 23. Each first bracket attachment portion 46 has a circular bracket-side insertion hole 46a. Each bracket-side insertion hole 46a extends through the corresponding first bumper-side attachment portion 46 in the thickness direction. The diameter of each bracket-side insertion hole 46a is the same as the diameter of the first insertion hole 23a of the corresponding first bumper-side attachment portion 23.

As shown in FIGS. 2 and 4, the bracket 40 includes three plate-shaped second extensions 47. The three second extensions 47 project from the distal end (second end in the transverse direction) of one of the two guide portions 42a of the second holder 42 that is farther from the first holder 41. The projection direction of each second extension 47 from the guide portions 42a corresponds to the transverse direction of the guide portions 42a. The distance between the second extensions 47 adjacent to each other in the longitudinal direction of the guide portion 42a is substantially the same as the distance between the connection portions 42b adjacent to each other in the longitudinal direction of the guide portions 42a.

Further, the bracket 40 includes plate-shaped second bracket attachment portions 48. The second bracket attachment portions 48 are continuous with the edges of the second extensions 47 on the side opposite from the guide portion 42a. The second bracket attachment portions 48 extend toward the opposite side from the first holder 41. The three second bracket attachment portions 48 are bracket attachment portions of the bracket 40. The three second bracket attachment portions 48 are spaced apart from each other by a predetermined distance in the longitudinal direction of the guide portion 42a. The distance between the second bracket attachment portions 48 adjacent to each other in the longitudinal direction of the guide portions 42a is substantially the same as the second bumper-side attachment portions 24 adjacent to each other in the longitudinal direction of the bumper extension 22. Each second bracket attachment portion 48 has an internal screw hole 48a.

As shown in FIGS. 2, 3, and 4, the bracket 40 is arranged inward from the rear bumper 20 in the vehicle 10. When the bracket 40 is arranged on the rear bumper 20, each first bracket attachment portion 46 is in contact with the corresponding first bumper-side attachment portion 23, and each second bracket attachment portion 48 is in contact with the corresponding second bumper-side attachment portion 24. Each first bracket attachment portion 46 is attached to the corresponding first bumper-side attachment portion 23 by a clip 50, and each second bracket attachment portion 48 is attached to the corresponding second bumper-side attachment portion 24 by a bolt 60. Thus, the bracket 40 is attached to the rear bumper 20.

Thus, each first bumper-side attachment portion 23 is an attaching portion of the rear bumper 20, to which the corresponding first bracket attachment portion 46 is attached. Further, each second bumper-side attachment portion 24 is an attaching portion of the rear bumper 20, to which the corresponding second bracket attachment portion 48 is attached.

As shown in FIG. 3, the clip 50 includes a tubular plastic clip body 51 and a plastic pin 52, which is inserted into the clip body 51. The clip body 51 includes a cylindrical insertion tube 51a and an annular flange 51b. The flange 51b projects in the radial direction from the basal end (first end in the axial direction) of the insertion tube 51a. The outer diameter of the insertion tube 51a is slightly smaller than the diameter of the bracket-side insertion hole 46a and the diameter of the first insertion hole 23a.

The pin 52 includes a columnar insertion portion 52a, which is inserted into the insertion tube 51a, and an annular flange 52b. The flange 52b projects in the radial direction from the basal end (first end in the axial direction) of the insertion portion 52a. The outer diameter of the insertion portion 52a is slightly larger than the inner diameter of the insertion tube 51a. The insertion portion 52a includes a tapered portion 52c at the second end in the axial direction, that is, the distal end located on the side opposite from the flange 52b. Further, the insertion portion 52a includes a circular flange 52d, which projects in the radial direction from the distal end of the tapered portion 52c. The outer diameter of the flange 52d is slightly larger than the inner diameter of the insertion tube 51a.

The insertion tube 51a of the clip body 51 extends through the first insertion hole 23a of the corresponding first bumper-side attachment portion 23 and the bracket-side insertion hole 46a of the corresponding first bracket attachment portion 46. The flange 51b is in contact with the lower surface of the first bumper-side attachment portion 23, that is, the surface on the side opposite from the first bracket attachment portion 46. Particularly, the flange 51b is in contact with the surrounding region of the first insertion hole 23a in the lower surface of the first bumper-side attachment portion 23. The insertion portion 52a of the pin 52 is forcibly inserted into the insertion tube 51a. This presses the insertion tube 51a against the first insertion hole 23a and the bracket-side insertion hole 46a. Thus, the outer circumferential surface of the insertion tube 51a is in close contact with the first insertion hole 23a and the bracket-side insertion hole 46a.

The close contact of the outer circumferential surface of the insertion tube 51a with the first bumper-side attachment portion 23 and the bracket-side insertion hole 46a engages the clip body 51 with the first bracket attachment portion 46 and the first bumper-side attachment portion 23. As a result, the first bracket attachment portion 46 is coupled to the first bumper-side attachment portion 23 by the clip body 51. Further, the flange 52d of the insertion portion 52a projects from a distal end of the insertion tube 51a to engage with the distal end, that is, the end of the insertion tube 51a located on the side opposite from the flange 51b. This limits the separation of the pin 52 from the clip body 51. As a result, the clip 50 remains attached to the first bracket attachment portion 46 and the first bumper-side attachment portion 23.

When the clip 50 is detached from the first bracket attachment portion 46 and the first bumper-side attachment portion 23, the pin 52 is forcibly pulled from the clip body 51. This cancels the close contact of the insertion tube 51a with the first insertion hole 23a and the bracket-side insertion hole 46a. As a result, the coupling of the first bracket attachment portion 46 to the first bumper-side attachment portion 23 by the clip body 51 is cancelled. In this manner, the clip 50 is detachable from the first bracket attachment portion 46 and the first bumper-side attachment portion 23. Accordingly, the clip 50 is a fastener that couples the first bracket attachment portion 46 and the first bumper-side attachment portion 23 that correspond to each other and is attachable to and detachable from the first bracket attachment portion 46 and the first bumper-side attachment portion 23.

As shown in FIG. 4, the bolt 60 includes a shaft 60a, which includes an external screw, and a head 60b, which projects in the radial direction from the basal end (first end in the axial direction) of the shaft 60a. The shaft 60a of the bolt 60 extends through the second insertion hole 24a of the corresponding second bumper-side attachment portion 24. The bolt 60 is screwed into the internal screw hole 48a of the second bracket attachment portion 48 until the head 60b comes into contact with the upper surface of the second bumper-side attachment portion 24, particularly, the surrounding region of the second insertion hole 24a of the upper surface. Thus, the second bracket attachment portion 48 is coupled to the second bumper-side attachment portion 24 by the bolt 60. Removing the shaft 60a of the bolt 60 from the internal screw hole 48a cancels the coupling of the second bracket attachment portion 48 and the second bumper-side attachment portion 24 by the bolt 60. In this manner, the bolt 60 is detachable from the second bracket attachment portion 48 and the second bumper-side attachment portion 24. Accordingly, the bolt 60 is a fastener that couples the second bracket attachment portion 48 and the second bumper-side attachment portion 24 that correspond to each other and is attachable to and detachable from the second bracket attachment portion 48 and the second bumper-side attachment portion 24.

In the attaching structure for the bracket 40 of the present embodiment, the bracket 40 is attachable to and detachable from the rear bumper 20. The attachment and detachment is implemented by the attachment and detachment of the clip 50 to and from the first bracket attachment portion 46 and the first bumper-side attachment portion 23 and the attachment and detachment of the bolt 60 to and from the second bracket attachment portion 48 and the second bumper-side attachment portion 24.

As shown in FIGS. 2 and 5, the bracket 40 includes a protection wall 49, which is arranged between the rear wheel 11 and the kick sensor 30. The protection wall 49 extends in a direction intersecting the traveling direction of the vehicle 10. The protection wall 49 extends from part of the coupling portion 43 in a direction intersecting the coupling portion 43. The protection wall 49 is located between the rear wheel 11 and the sensor ECU 33. The protection wall 49 is arranged so as to intersect an entry path R1 for a stone thrown from the rear wheel 11 toward the sensor ECU 33 while the vehicle 10 is traveling. The entry path R1 has been calculated in advance through, for example, experiments.

The operation of the present embodiment will now be described.

To assemble the attaching structure for the bracket 40 having the above-described configuration, one or more clips 50 are first used to couple the first bracket attachment portion 46 and the first bumper-side attachment portion 23 that correspond to each other. This temporarily fixes the bracket 40 to the rear bumper 20. In other words, the bracket 40 is positioned relative to the rear bumper 20. Subsequently, one or more bolts 60 are used to couple the second bracket attachment portion 48 and the second bumper-side attachment portion 24 that correspond to each other. This fully fixes the bracket 40 to the rear bumper 20. In other words, the bracket 40 is attached to the rear bumper 20.

For example, to detach the bracket 40 attached to the rear bumper 20 for maintenance, the bolt 60 is detached from the second bracket attachment portion 48 and the second bumper-side attachment portion 24 and then the clip 50 is detached from the first bracket attachment portion 46 and the first bumper-side attachment portion 23. This cancels the coupling of the second bracket attachment portion 48 and the second bumper-side attachment portion 24 by the bolt 60 and cancels the coupling of the first bracket attachment portion 46 and the first bumper-side attachment portion 23 by the clip 50. In other words, the bracket 40 is detached from the rear bumper 20.

To attach the bracket 40 to the rear bumper 20 again, the detached clip 50 is again attached to the first bracket attachment portion 46 and the first bumper-side attachment portion 23. Further, the detached bolt 60 is again coupled to the second bracket attachment portion 48 and the second bumper-side attachment portion 24. Thus, the previously-used clip 50 is used to attach the first bracket attachment portion 46 and the first bumper-side attachment portion 23 to each other, and the previously-used bolt 60 is used to attach the second bracket attachment portion 48 and the second bumper-side attachment portion 24 to each other. In other words, the bracket 40 can be coupled to the rear bumper 20 again by using the previously-used fasteners.

The protection wall 49 is arranged between the rear wheel 11 and the sensor ECU 33. Thus, foreign matter such as a stone thrown from the rear wheel 11 toward the sensor ECU 33 while the vehicle 10 is traveling, that is, a flying stone, strikes the protection wall 49. Accordingly, the protection wall 49 prevents a flying stone from striking the sensor ECU 33 while the vehicle 10 is traveling.

The above-described embodiment provides the following advantages.

(1) The clip 50, which is attachable to and detachable from the first bracket attachment portion 46 and the first bumper-side attachment portion 23, is used to couple the first bracket attachment portion 46 and the first bumper-side attachment portion 23 to each other. Further, the bolt 60, which is attachable to and detachable from the second bracket attachment portion 48 and the second bumper-side attachment portion 24, is used to couple the second bracket attachment portion 48 and the second bumper-side attachment portion 24 to each other. Thus, the bracket 40 is attached to the rear bumper 20. Detaching the clip 50 from the first bracket attachment portion 46 and the first bumper-side attachment portion 23 cancels the coupling of the first bracket attachment portion 46 and the first bumper-side attachment portion 23 by the clip 50. Further, detaching the bolt 60 from the second bracket attachment portion 48 and the second bumper-side attachment portion 24 cancels the coupling of the second bracket attachment portion 48 and the second bumper-side attachment portion 24 by the bolt 60. Thus, the bracket 40 is detached from the rear bumper 20. To attach the bracket 40 to the rear bumper 20 again, the clip 50 detached once from the first bracket attachment portion 46 and the first bumper-side attachment portion 23 is again attached to the first bracket attachment portion 46 and the first bumper-side attachment portion 23 to couple the first bracket attachment portion 46 and the first bumper-side attachment portion 23 to each other. Further, the bolt 60 detached once from the second bracket attachment portion 48 and the second bumper-side attachment portion 24 is again attached to the second bracket attachment portion 48 and the second bumper-side attachment portion 24 to couple the second bracket attachment portion 48 and the second bumper-side attachment portion 24 to each other. Thus, the bracket 40 is attached to the rear bumper 20 again.

This overcomes the problem that occurs when the bracket 40 is attached to the rear bumper 20 again using a double-sided tape that has been taken off once. In other words, the bracket 40 is prevented from being attached to the rear bumper 20 unstably. Further, there is no need to prepare a new double-sided tape every time the bracket 40 is attached to the rear bumper 20 again. This reduces the cost. The above-described structure ensures the reliability of attaching the bracket 40 to the rear bumper 20 while reducing the cost.

(2) Screwing the bolt 60 into the second bracket attachment portion 48 couples the second bracket attachment portion 48 and the second bumper-side attachment portion 24 to each other by the bolt 60. Further, engaging the clip 50 with the first bracket attachment portion 46 and the first bumper-side attachment portion 23 couples the first bracket attachment portion 46 and the first bumper-side attachment portion 23 to each other by the clip 50. The bolt 60 screwed into the second bracket attachment portion 48 is a fastener that couples the second bracket attachment portion 48 and the second bumper-side attachment portion 24 to each other and is attachable to and detachable from the second bracket attachment portion 48 and the second bumper-side attachment portion 24. The clip 50 engaged with the first bracket attachment portion 46 and the first bumper-side attachment portion 23 is a fastener that couples the first bracket attachment portion 46 and the first bumper-side attachment portion 23 to each other and is attachable to and detachable from the first bracket attachment portion 46 and the first bumper-side attachment portion 23.

(3) The bracket 40 includes the protection wall 49, which is arranged between the rear wheel 11 of the vehicle 10 and the sensor ECU 33 of the kick sensor 30 to extend in the direction intersecting the traveling direction of the vehicle 10. Foreign matter such as a stone thrown from the rear wheel 11 toward the sensor ECU 33 while the vehicle 10 is traveling strikes the protection wall 49. Accordingly, the protection wall 49 prevents a flying stone from striking the sensor ECU 33 while the vehicle 10 is traveling. This eliminates the need to arrange an additional protection member that protects the sensor ECU 33 from a flying stone while the vehicle 10 is traveling and thus reduces the number of components.

The above illustrated embodiment may be modified as follows. The above-described embodiments and the following modifications can be combined as long as the combined modifications remain technically consistent with each other.

The bracket 40 may be attached to the rear bumper 20 only by the clip 50, without using the bolt 60. Alternatively, the bracket 40 may be attached to the rear bumper 20 only by the bolt 60, without using the clip 50. In short, the fastener simply needs to include at least one of the bolt 60 and the clip 50.

Further, the second bracket attachment portion 48 and the second bumper-side attachment portion 24 may be coupled to each other by the bolt 60 by screwing the bolt 60 into the second bumper-side attachment portion 24. In short, the second bracket attachment portion 48 and the second bumper-side attachment portion 24 simply need to be coupled to each other by the bolt 60 by screwing the bolt 60 into the second bracket attachment portion 48 or the second bumper-side attachment portion 24.

The bracket 40 does not have to include the protection wall 49. In this case, the vehicle 10 may include an additional protection member that protects the sensor ECU 33 from a flying stone.

The bracket 40 does not have to be attached to the rear bumper 20 using the clip 50 at two positions. Instead, for example, the bracket 40 may be attached to the rear bumper 20 using the clip 50 at one position or three or more positions.

The bracket 40 does not have to be attached to the rear bumper 20 using the bolt 60 at three positions. Instead, for example, the bracket 40 may be attached to the rear bumper 20 using the bolt 60 at one position, two positions, or four or more positions.

The vehicle 10 may include a sliding door that opens and closes automatically by detecting the motion of the leg 12 of the user. In this case, the kick sensor 30 should be attached to a decorative part such as an aerodynamic part, which is part of the body arranged on the lower side of the sliding door, using the bracket 40.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An attaching structure for a bracket used to attach a kick sensor to a body of a vehicle, the attaching structure comprising:
a bracket attachment portion arranged on the bracket;
an attaching portion arranged on the body; and
a fastener that couples the bracket attachment portion and the attaching portion to each other, the fastener being attachable to and detachable from the bracket attachment portion and the attaching portion.

2. The attaching structure according to claim 1, wherein the fastener includes at least one of a bolt or a clip.

3. The attaching structure according to claim 1, wherein the bracket includes a protection wall arranged between a wheel of the vehicle and the kick sensor, the protection wall extending in a direction intersecting a traveling direction of the vehicle.
